(19) United States
(12) Patent Application Publication
(10) Pub. No.: US 2008/0285565 A1
(43) Pub. Date: Nov. 20, 2008

(54) SYSTEMS AND METHODS FOR CONTENT INSERTION WITHIN A ROUTER

(75) Inventor: Jacob H. Gunther, North Logan, UT (US)

Correspondence Address: UTAH STATE UNIVERSITY, TECHNOLOGY COMMERCIALIZATION OFFICE, 570 RESEARCH PARK WAY, SUITE 101, NORTH LOGAN, UT, 84341, US

(73) Assignee: UTAH STATE UNIVERSITY, North Logan, UT (US)

(21) Appl. No.: 11/735,285

(22) Filed: Apr. 13, 2007

Related U.S. Application Data
(60) Provisional application No. 60/865,978, filed on Nov. 15, 2006.

(51) Int. Cl. H04L 12/28

(52) U.S. Cl. 370/394; 370/400

(57) ABSTRACT

Systems and methods are provided for inserting content into messages being sent between systems or networks. A router according to one embodiment automatically inserts new content within a received data packet. Before insertion, the router may determine that the received data packet corresponds to a certain type of message such as a web page, an e-mail, or a text message. The router may also determine whether the packet includes a predetermined insertion point in the corresponding message. The predetermined insertion point may be, for example, an end of the web page, e-mail, or text message. The type of message and/or the subject matter of the inserted content may be based on user selectable preferences. In one embodiment, a plurality of packets are received before the new content is inserted into the message to improve reliability and/or allow message decoding.

### RELATED APPLICATION

This application claims the benefit under 35 U.S.C. § 119(e) of U.S. Provisional Application No. 60/865,978, filed Nov. 15, 2006, which is hereby incorporated by reference herein in its entirety.

### TECHNICAL FIELD

This disclosure relates generally to communication systems and methods. More specifically, this disclosure relates to inserting content into a message being sent between two networks or systems.

### BRIEF DESCRIPTION OF THE DRAWINGS

Non-limiting and non-exhaustive embodiments of the disclosure are described, including various embodiments of the disclosure with reference to the figures in which:

FIG. 1 is a block diagram of a client and a server communicating with each other through a plurality of routers in a wide area network;

FIG. 2 is a block diagram of an example router according to one embodiment;

FIGS. 3A-3C are general representations of an example web browser displaying a web page and inserted content according to certain embodiments;

FIG. 4 is a general representation of an example computer user interface displaying an e-mail and inserted content according on one embodiment;

FIG. 5 is a flow chart of parallel processes for routing and inserting content into messages according to one embodiment;

FIG. 6 is a flow chart of a process for handling errors according to one embodiment;

FIG. 7 is a flow chart of a process for inserting content into a data packet at a predetermined insertion location according to one embodiment;

FIG. 8 is a flow chart of a process for inserting content into a packet comprising compressed or encoded data according to one embodiment;

FIG. 9 is a flow chart of a process for simulating a connection between a client and a server according to one embodiment;

FIG. 10 is a block diagram of a TCP/IP connection between a client application and a server application according to one embodiment;

FIG. 11 is a block diagram of a general protocol stack for communication between a client application and a server application according to one embodiment;

FIGS. 12A-12C are block diagrams illustrating a protocol stack on the client host and the server host shown in FIG. 10 according to one embodiment;

FIG. 13 is a block diagram illustrating a data encapsulation process according to one embodiment;

FIG. 14 is a block diagram illustrating a data structure of a TCP segment according to one embodiment;

FIG. 15 is a block diagram illustrating a data structure of an IP datagram according to one embodiment;

FIG. 16 illustrates an example timing chart of a transaction for establishing a TCP connection using three TCP segments according to one embodiment;

FIG. 17 illustrates an example timing chart of a transaction for terminating a TCP connection using four TCP segments according to one embodiment; and

FIG. 18 illustrates an example timing chart of a transaction for inserting content into an e-mail according to one embodiment.

### DETAILED DESCRIPTION

Overview

Systems and methods are provided for inserting content into messages being sent between systems or networks. The inserted content may include, for example, public service announcements such as an announcement from a government agency. The government agency may be, for example, a local, regional, or national government agency. Example announcements include, but are not limited to, storm warnings, tornado warnings, hurricane warnings, warnings for other types of natural disasters, homeland security warnings or advisories, abduction advisories (e.g., AMBER Alerts), and any other type of public, private or commercial message.

The message into which the new content is inserted may be, for example, a web page, an e-mail, a text message, an image, streaming video, a text document, or other types of messages.

In one embodiment, a router automatically inserts new content within a received data packet. Before insertion, the router may determine that the received data packet corresponds to a certain type of message such as a web page, an e-mail, or a text message. The router may also determine whether the packet includes a predetermined insertion point in the corresponding message. The predetermined insertion point may be, for example, an end or beginning of the web page, e-mail, or text message. The type of message and/or the subject matter of the inserted content may be based on user selectable preferences. In one embodiment, a plurality of packets are received before the new content is inserted into the message to improve reliability and/or allow message decoding.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are neither shown nor described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

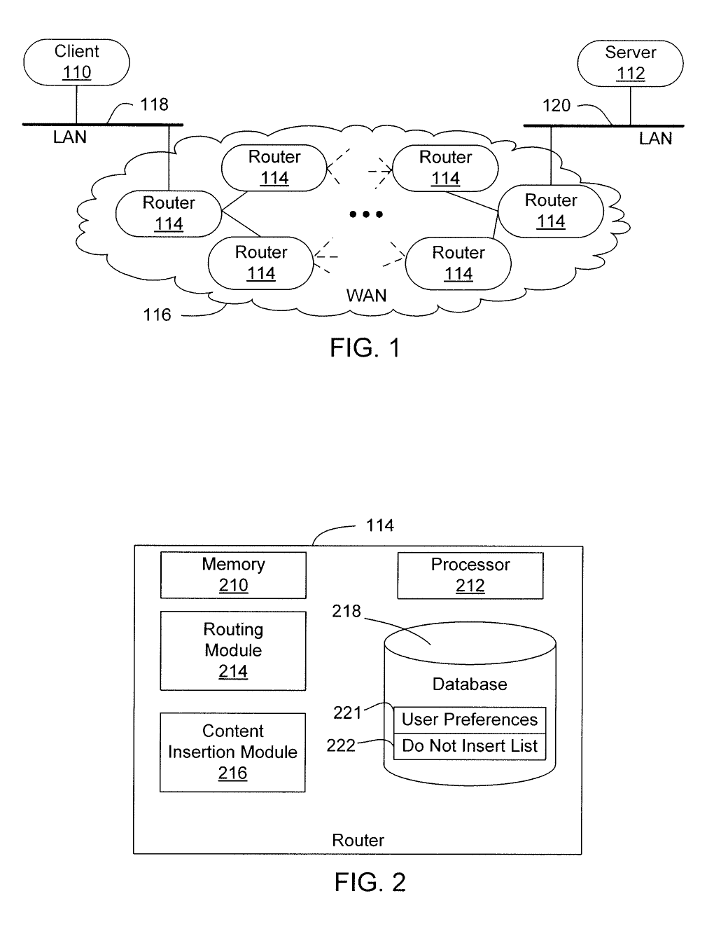

FIG. 1 is a block diagram of a client application 110 and a server application 112 capable of communicating with each other through a plurality of routers 114 interconnected in a wide area network (WAN) 116. The WAN 116 may include, for example, the Internet or World Wide Web. The client application 110 and/or the server application 112 may be respectively hosted by a wide variety of computer devices such as servers, workstations, desktop computers, laptop computers, personal digital assistants (PDAs), cellular telephones, kiosks, point-of-sale terminals, and other computing devices. As shown in FIG. 1, the client 110 and/or the server 112 may be connected to the WAN 116 through a respective local area network (LAN) 118, 120. Alternatively, one or both of the client 110 and the server 112 may be connected directly to the WAN 116 (e.g., through a modem).

The server application 112 may be configured, for example, to provide web pages and linked documents (e.g., images and other web page content). As another example, the server application 112 may be configured to send and receive e-mails, text messages, streaming video, or other types of messages. Similarly, the client application 110 may be configured, for example, for viewing web pages (e.g., a web browser), e-mail, text messages, streaming video, combinations of the foregoing, or other types of messages.

The routers 114 are configured to forward messages across the WAN 116 toward a destination address. For example, the routers 114 may forward a request from the client application 110 to the server application 112. As another example, the routers 114 may forward messages (e.g., web page content, e-mails, text messages, images, video or other message types) from the server application 112 to the client application 110. In one embodiment, one or more of the routers 114 along a path between the client application 110 and the server application 112 are configured to insert content into the messages received from the server application 112 before sending the modified messages to client application 110.

### EXAMPLE ROUTER

FIG. 2 is a block diagram of an example router 114 according to one embodiment. The example router 114 includes a memory device 210, a processor 212, a routing module 214, and a content insertion module 216. In one embodiment, the routing module 214 is configured to forward data packets toward a destination address. The routing module 214 may communicate with other routers 114 in the WAN 116 using standard routing protocols to create and maintain a routing table. The routing table may store, for example, preferred routes to network destinations and the path to a next hop router 114 for each route. As discussed in detail below, the routing module 214 may be associated with the Internet Protocol (IP). However, artisans will recognize from the disclosure herein that other types of routing protocols may also be used.

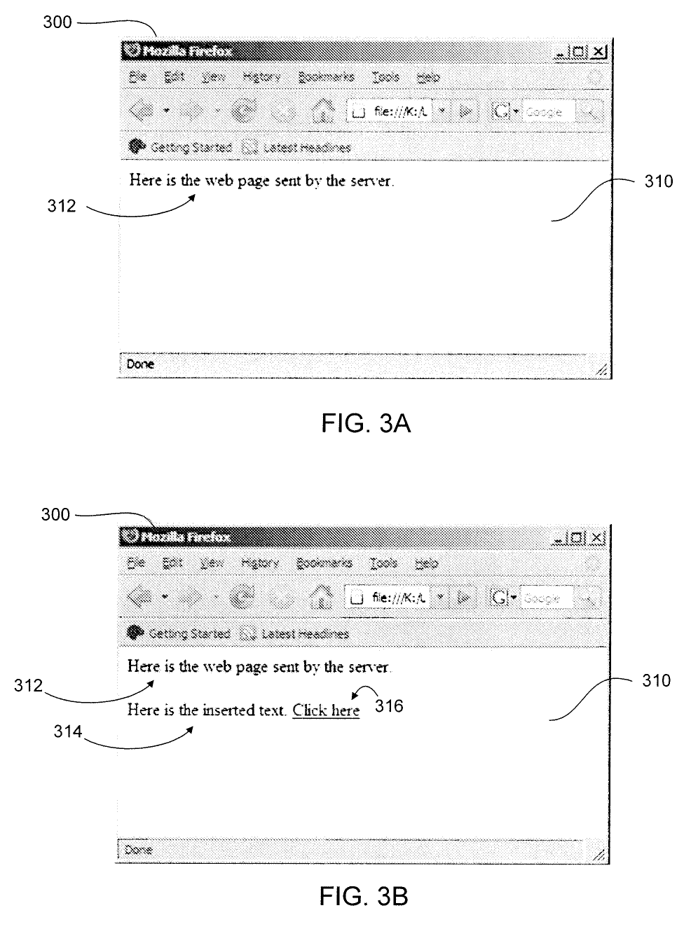

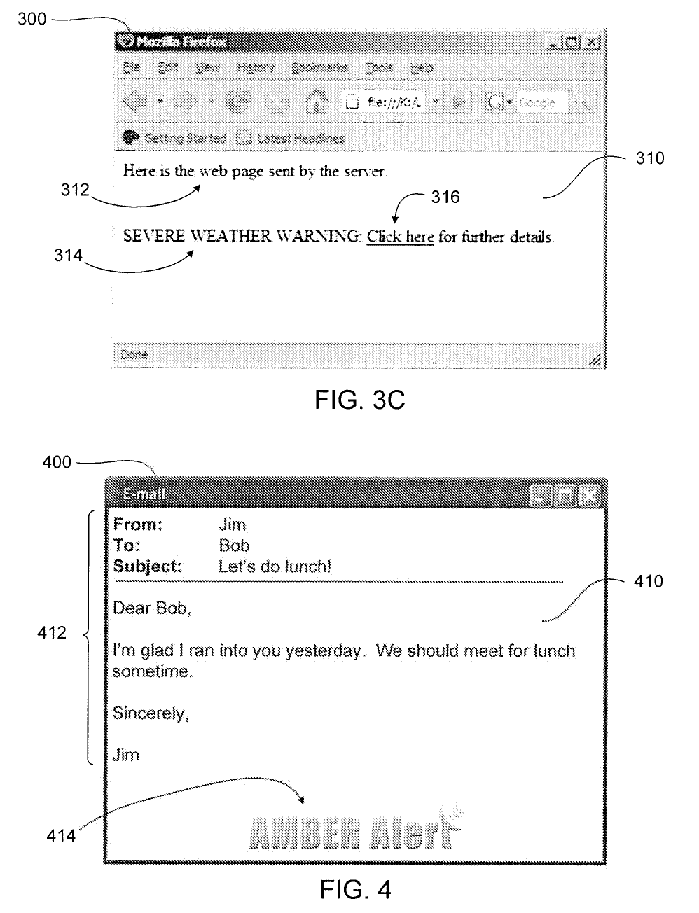

The content insertion module 216 is configured to insert content into messages being routed by the routing module 214. For example, FIGS. 3A-3C are general representations of an example web browser 300 displaying a web page 310 and inserted content according to certain embodiments. In FIG. 3A, the web page 310 sent from the server application 112 to the client application 110 includes original content 312 (“Here is the web page sent by the server.”). After the original content 312 for the web page 310 is received by the router 114 shown in FIG. 2, the content insertion module 216 inserts new content 314 at a predetermined location in the web page 310. For example, as shown in FIG. 3B, the content insertion module 216 may be configured to insert text (“Here is the inserted text.”) and a hyper-text link 316 after the original content 312 in the web page 310. In addition to text and links 316, the new content 314 may also include graphics, video, audio, or other types of web page content.

As shown in FIG. 3, in one embodiment, the new content 314 inserted into the web page 310 may comprise a public announcement or warning. In this example, the new content 314 includes the text “SEVERE WEATHER WARNING: Click here for further details.” The hyper-link (“Click here”) may direct the browser 300 to a web page that provides additional information about the public announcement or warning. For example, the link 316 may direct the web browser 300 to a web page provided by the National Weather Agency or other agency or entity (e.g., government or news agency) that may provide a user of the client application 110 with details such as the severity of the storm, the geographic areas included in the warning, and recommended precautions.

An artisan will recognize from the disclosure herein that the new content 314 inserted by the insertion module 216 is not limited to weather warnings. Other types of content that may be inserted by the content insertion module 216 may include, but are not limited to, hurricane warnings, tornado warnings, flood warnings, suspected terrorist or other homeland security threats, emergency instructions, air quality advisories, public notices, traffic reports, stock reports, advertisements, private messages, combinations of the foregoing, and other types of information.

For example, FIG. 4 is a general representation of an example computer user interface 400 displaying an e-mail 410 having original e-mail content 412 and new content 414 inserted by the content insertion module 216 according on one embodiment. In this example, the new content 414 comprises an “AMBER Alert” inserted at the beginning or end of the e-mail 410. In many parts of the United States and Canada, AMBER Alerts are notifications to the general public of a confirmed child abduction and are generally distributed via commercial radio stations and television stations via the Emergency Alert System. Inserting an AMBER Alert in the e-mail 410 provides for quick and effect distribution of current information related to a child abduction. The new information 414 may include a link to further information, a picture of the abducted child and/or suspected abductor, clothing descriptions, last known location and direction of travel, maps, and/or vehicle description.

In one embodiment, the router 114 includes or has access to a database 218 comprising user preferences 221. Although not shown in FIG. 2, an artisan will understand from the disclosure herein that the user preferences 221 and/or a “do not insert list” 222 (discussed below) may be stored externally to the router 114 such as in a remote database (not shown). Thus, a plurality of routers 114 may access the user preferences 221 and/or the do not insert list 222 from a central location. The user preferences 221 allow users to select the types of content that the users would like to receive and/or the types of messages that allow for content insertion. For example, a user may select to be notified of regional or local natural disasters or warnings. Another user may select to be notified only of local AMBER Alerts. Another user may specify the types of products or services for which the user would like to receive advertisements. Yet another user may select to have new content inserted only into e-mail or text messages (e.g., not into web pages).

In addition, or in another embodiment, users sending messages may select the types of content that may be inserted into sent messages and/or the types of messages that allow for content insertion. For example, a user may decide to allow the user's web site and/or sent e-mails to have AMBER Alerts inserted therein during transmission. Further, a user may decide, in exchange for a fee, to allow advertisements or other content to be inserted into the user's web site and/or e-mails.

In one embodiment, users may selectively decide to be included in a “do not insert list” 222 such that the messages (e.g., web pages, e-mails, text messages, graphics, video, etc.) they receive and/or send through the WAN 116 do not have new content inserted therein. Thus, in certain embodiments, users may selectively control the new content inserted in their messages (incoming or outgoing).

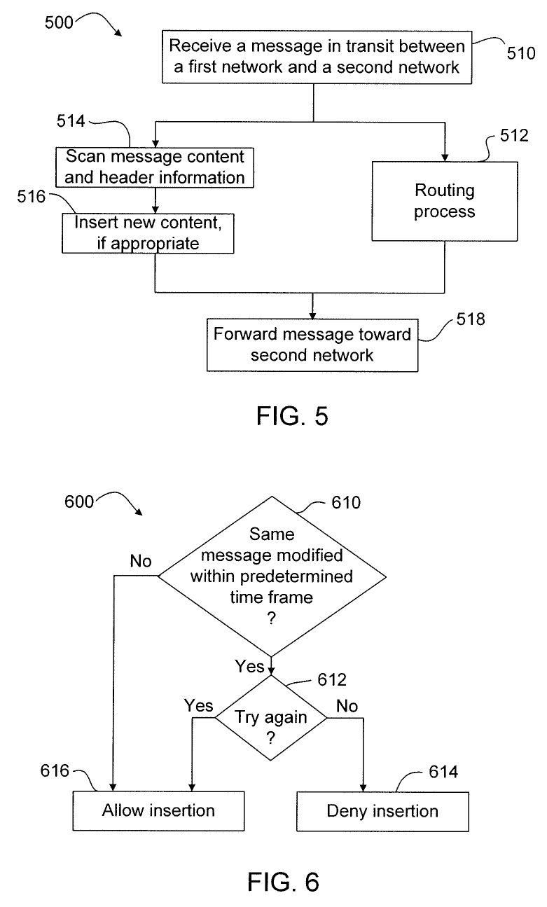

FIG. 5 is a flow chart of parallel processes 500 for routing and inserting content into messages according to one embodiment. The process 500 is useable, for example, by the example router 114 shown in FIG. 2. The process 500 includes receiving 510 a message in transit between a first network (e.g., the LAN 120) and a second network (e.g., the LAN 118). After the router 114 receives the message, the routing module 512 performs a routing process 512 to determine how to forward the received message toward the second network (e.g., the LAN 118).

The content insertion module 216 also scans 514 the message content and header information to determine the type of message (e.g., web page, e-mail, text message, graphic, video, etc.) and inserts 516 new content into the message, if appropriate. As discussed above, the appropriateness of message insertion may depend on the user preferences 221 and/or the do not insert list 222. In addition, or in other embodiments, the appropriateness of message insertion may depend on the type of message received by the router 114. For example, the content insertion module 216 may be configured to only insert new content into web pages or e-mail. After the content insertion module 216 inserts the new content (or determines that it is inappropriate to insert the new content), the routing module 214 forwards 518 the message toward the second network (e.g., the LAN 118).

The parallel process 500 for routing and inserting content into messages is generally fast, efficient, and does not alter the original content of the message being routed. However, to eliminate or reduce the likelihood of preventing messages from being delivered to their intended destinations, one embodiment monitors messages that are resent, possibly due to failed delivery, and decides whether or not to retry the content insertion.

For example, FIG. 6 is a flow chart of a process 600 for handling errors according to one embodiment. The process 600 includes determining 610 whether a received message is the same message that was modified within a predetermined time frame. For example, if the content insertion module 216 determines that a received message had previously been modified and forwarded to the same intended destination within a predetermined period (e.g., within the last thirty seconds, one minute, five minutes, or some other predetermined time period), then the content insertion module 216 assumes that the message is being resent because it did not arrive at the intended destination.

If the same message has been modified within the predetermined time frame, then the content insertion module 216 determines 612 whether to try modifying and forwarding the message again. For example, in one embodiment, the content insertion module 216 allows 616 insertion of the new content and tries to send the modified message a predetermined number of times (e.g., twice, three times, or some other predetermined number of times) before denying 614 insertion of the new content. In another embodiment, the content insertion module 216 denies 614 insertion anytime a received message was previously modified within the predetermined time frame.

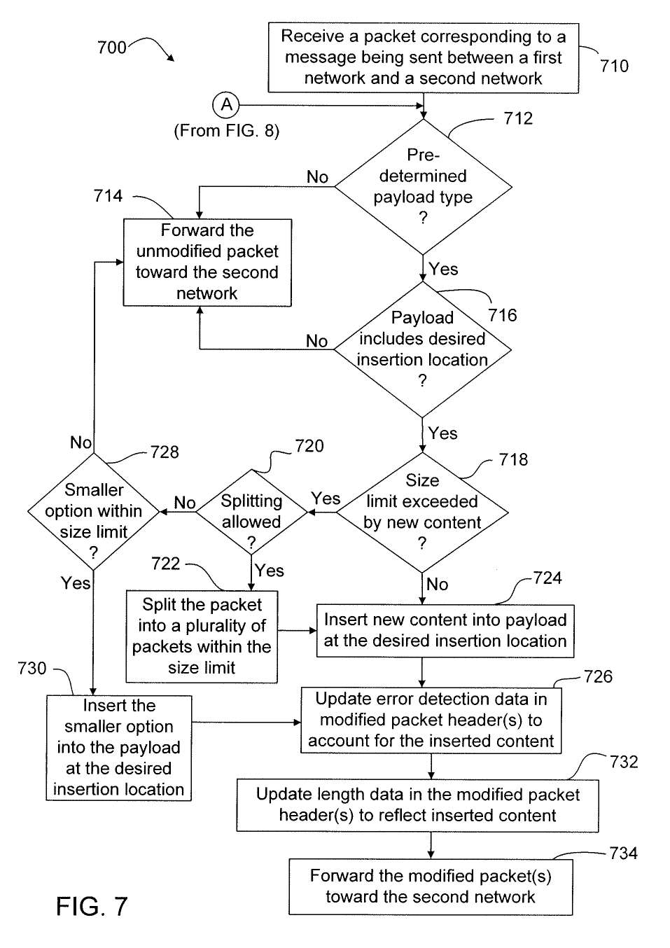

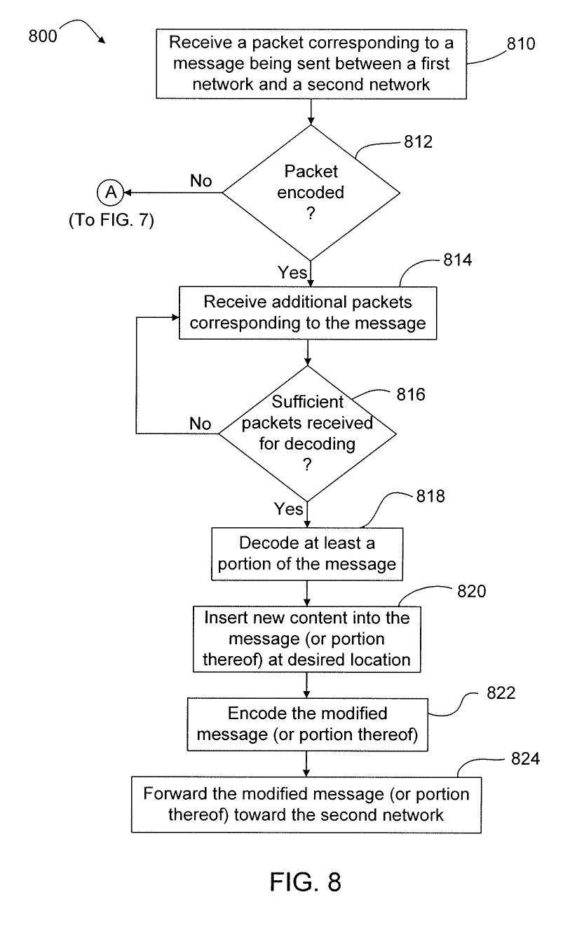

FIG. 7 is a flow chart of a process 700 for inserting content into a data packet at a predetermined insertion location according to one embodiment. The process 700 includes receiving 710 (e.g., at the example router 114 in the WAN 116) a data packet corresponding to a message being sent between a first network (e.g., the LAN 120) and a second network (e.g., the LAN 118). As those skilled in the art will recognize, a data packet comprises a formatted block of information carried by a computer network (e.g., the WAN 116 and LANs 118, 120) and generally includes header information (e.g., including a destination address, error detection data, packet length data, and other processing information) and payload information. In certain example embodiments discussed below, data packets may be referred to as “IP datagrams.”

After the example router 114 receives the data packet, the content insertion module 216 determines 712 whether the received packet includes a predetermined payload type. For example, the content insertion module 216 may scan the received packets to determine if they correspond to a portion of a web page, e-mail or text message. If the received packet does not correspond to the predetermined payload type, then the insertion module 216 does not insert new content into the packet and the routing module 214 forwards 714 the unmodified packet toward the second network (e.g., the LAN 118).

If, however, the packet does correspond to the predetermined payload type (e.g., the packet corresponds to a web page), then the content insertion module 216 determines 716 whether the packet's payload includes a desired insertion location. For example, the content insertion module 216 may be configured to insert the new content at the bottom or end of a web page. Thus, in such an embodiment, the content insertion module 216 analyzes the payload of the received packet to determine whether the payload includes a portion of the web page data corresponding to the end of the web page. If the payload does not include the desired insertion location (e.g., it does not include the end of the web page), then the content insertion module 216 does not insert the new content into the packet and the routing module 214 forwards 714 the unmodified packet toward the second network.

While the desired insertion location may be at the end of the web page, as in the above example, the disclosure herein is not so limited. Indeed, the desired insertion location may be at the beginning of the web page or at any other location. For example, in one embodiment, the desired insertion location may be in a table that may be to the right or left side of the original web page content. As another example, the desired insertion location may be mixed with the original content such that original text wraps around the new content. In one such embodiment, an icon such as an arrow or other graphic may be inserted in the upper portion or middle of the web page to alert a user that additional new content has been inserted at the bottom of the web page. Other desired insertion locations will occur to those of skill in the art from reading the disclosure herein. Further, in some embodiments, the new content need not be inserted at a single location. For example, the new content may include changing the background color of a web page, e-mail or text message.

If the payload does include the desired insertion location, then the content insertion module 216 determines 718 whether a size limit would be exceeded by adding the new content to the payload. In certain embodiments, packets routed through the WAN 116 (or a portion thereof) include size limits that cannot be exceeded. Thus, if the size limit will be exceeded by adding the new content to the packet, the content insertion module 216 determines 720 whether splitting of the packet into a plurality of smaller packets is allowed. As discussed in detail below, splitting the packet into smaller packets may be referred to herein as “fragmentation.” If splitting is allowed, the content insertion module 216 splits 722 (e.g., fragments) the received packet into a plurality of packets such that the size limit is not exceeded by any of the packets when the new content is added.

If the size limit will not be exceeded, or if the packet is split such that the size limit will not be exceeded, the content insertion module 216 inserts 724 the new content into the packet's payload at the desired insertion location. If, for example, the packet was split, the content insertion module inserts the new content into one of the plurality of packets that includes the desired insertion location (e.g., the packet that includes the end of the web page). The content insertion module 216 then updates the error detection data in the modified packet's header (or headers if the packet was split) to account for the inserted content.

If splitting the packet is not allowed, the content insertion module 216 determines 728 whether a smaller option within the size limit is available for the new content. Splitting may not be allowed, for example, if the packet's header information includes a “Do not Fragment” flag or if a protocol that does not allow fragmentation (e.g., IPv6) is being used. Smaller options for the new content allow for content insertion in a such situations. For example, a router 114 directing web pages or e-mails to mobile phone applications may have a smaller packet size limit (e.g., due to limited processing power available in mobile phones) than that used for other client applications. In such applications, the content insertion module 216 may insert a smaller option (e.g., simple text and/or a single link) into the packet rather than a larger option (e.g., a large amount of formatted text, multiple links, graphics, and/or other content) used when larger packets are allowed.

If a smaller option for the new content is available, the content insertion module 216 inserts 730 the smaller option into the payload at the desired insertion location. The content insertion module 216 then updates 726 the error detection data in the modified packet header to account for the inserted content. If, however, a smaller option is not available for the new content, the content insertion module 216 does not insert the new content and the routing module 214 forwards 714 the unmodified packet toward the second network.

The content insertion module 216 also updates 732 the length data in the modified packet header(s) to reflect the inserted content. The routing module 214 then forwards 734 the modified packet(s) toward the second network.

As discussed in detail below, a message may comprise, for example, a plurality of packets that are each forwarded by one or more of the routers 114 in the WAN 116. In the embodiment illustrated in FIG. 7, received packets are individually analyzed to determine whether they are of the desired payload type (e.g., part of a web page) and whether they include the desired insertion location (e.g., the end of the web page).

However, in other embodiments, a message may be encoded so as to be transmitted between the server application 112 and the client application 110 in a compressed format. In certain such embodiments, all or at least a portion of the packets corresponding to the encoded message (e.g., web page) may need to be received to decode the message (or a portion thereof so that the content insertion module 216 may insert new content at a desired insertion location.

For example, FIG. 8 is a flow chart of a process 800 for inserting content into a packet comprising compressed or encoded data according to one embodiment. The process 800 includes receiving 810 a packet corresponding to a message being sent between a first network (e.g., the LAN 120) and a second network (e.g., the LAN 118). After receiving the packet, the content insertion module 216 determines whether the received packet is encoded. If the received packet is not encoded, the process 800 proceeds to step 712 shown in FIG. 7.

If, however, the packet is encoded, the content insertion module 216 instructs the router 114 to continue receiving 814 additional packets corresponding to the message until the content insertion module 216 determines 814 that a sufficient number of packets have been received to decode the message or a portion thereof. The content insertion module 216 then decodes 818 at least a portion of the message and, if appropriate (e.g., the encoded message includes a predetermined payload type and/or desired insertion location), inserts 820 the new content into the message (or portion thereof at the desired location. Although not shown in FIG. 8, the content insertion module 216 may also handle splitting (fragmentation) and modifying error detection data and length data, as shown in FIG. 7.

The content insertion module 216 may then encode 822 the modified message (or portion thereof. The encoding may include re-packetizing the message. The routing module 214 then forwards 824 the modified message (or portion thereof toward the second network (e.g., the LAN 118).

In certain embodiments, there is a high probability that each packet corresponding to the message will traverse the same path (e.g., sequence of routers 116) through the WAN 116. Thus, it is sufficiently likely that the content insertion module 216 will be able to decode the message. However, in other embodiments, the data packets corresponding to a particular message may not be guaranteed to traverse the same path through the WAN 116. Thus, decoding and/or content insertion may not be possible if one or more of the packets corresponding to the message traverse different paths through the WAN 116. In such embodiments, the router 114 may be configured to guarantee or increase the likelihood of receiving enough packets corresponding to the message in order to insert the new content.

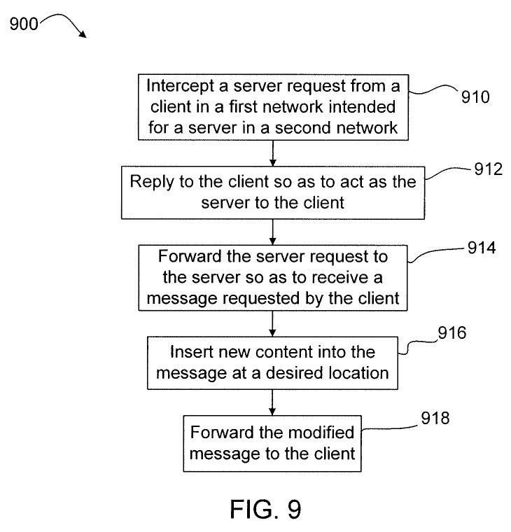

For example, FIG. 9 is a flow chart of a process 900 for simulating a connection between a client (e.g., the client application 110) and a server (e.g., the server application 112) according to one embodiment. The process includes intercepting 910 a server request from a client in a first network intended for a server in a second network. After receiving a server request, the content insertion module 216 replies 912 to the client so as to act as the server to the client. The content insertion module 216 then forwards 914 the server request to the server so as to receive a message requested by the client.

After receiving the message sent by the server, the content insertion module 216 inserts 916 new content into the message at a desired location. The routing module 214 then forwards 918 the modified message to the client. By simulating the connection, the content insertion module 216 receives all of the packets corresponding to the message from the server. Thus, the content insertion module 216 may decode the message, insert the new content therein, and re-encode the message.

An artisan will understand from the disclosure herein that the process 900 shown in FIG. 9 may also be used to insert new content into a message sent from the client application 110 to the server application 112. For example, as discussed in more detail below, the client application 110 may be sending an e-mail to the server application 112 (e.g., an e-mail server). After replying 912 to the client so as to act as the server to the client, the content insertion module 216 receives the e-mail from the client application 110, inserts new content into the e-mail, and forwards the modified e-mail to the server application 112.

### EXAMPLE EMBODIMENTS USING HTTP AND/OR SMTP

The following disclosure of particular network configurations and protocols are provided by way of example only. In particular, the following disclosure describes the function of the hypertext transfer protocol (HTTP) and simple mail transfer protocol (SMTP) protocols, how they use the transmission control protocol (TCP) layer, how TCP uses the internet protocol (IP), and what happens to enable the insertion of content into web pages (e.g., using HTTP) and e-mail (e.g., using SMTP). Variations are also described. However, artisans will recognize from the disclosure herein that other network configurations and/or protocols may also be used.

IP Addresses

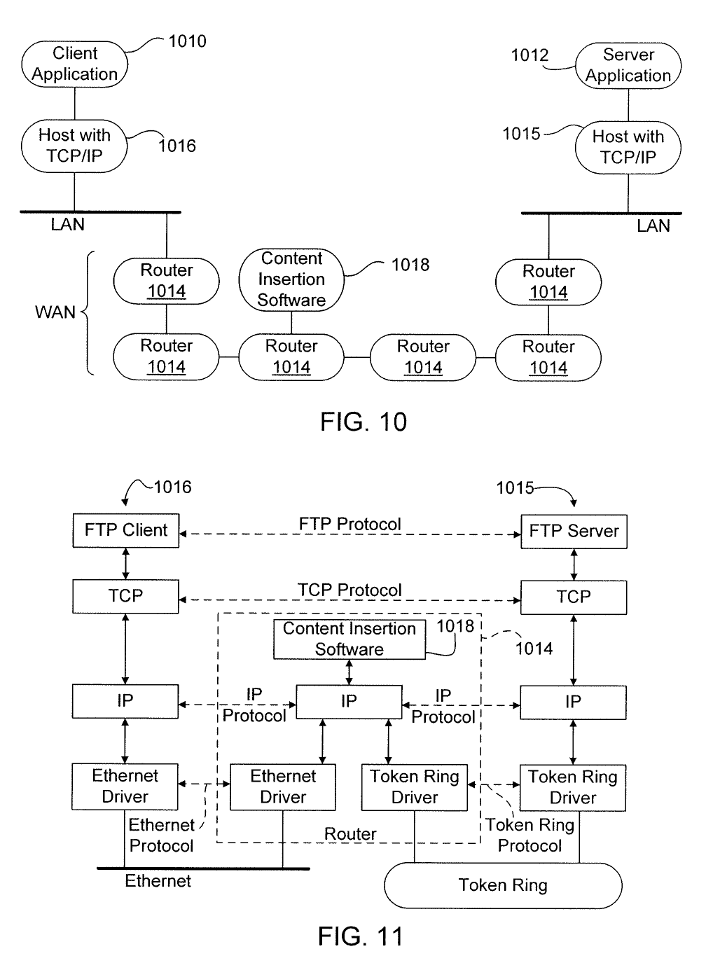

Internet addresses (also known as IP addresses) are 32-bit numbers. Every interface (physical connection) connected to the Internet must have a unique IP address. A host may connect to the Internet at two or more interfaces. Such a system is called multi-homed. A computer sitting on a desk in an office usually has only one interface and therefore has only one IP address. On the other hand, a router connects two or more networks and routes IP datagrams from one network to another. See, FIG. 10 illustrating a block diagram of a TCP/IP connection between a client application 1010 and a server application 1012. See also, FIG. 11 illustrating a block diagram of a general protocol stack for communication between the client application 1010 and the server application 1012. Therefore, a router 1014 will have multiple interfaces and there will be one IP address assigned to each interface. Routers 1014 are multi-homed.

Application Port Numbers

TCP identifies the application using its services by the application's 16-bit port number (also known as port addresses). Port numbers for server applications 1012 and client applications 1010 are chosen and assigned differently. Server applications 1012 have well-known port numbers. For example, HTTP servers are always assigned port number 80. It is the combination of the server's 32-bit IP address and the server application's 16-bit port number that enable a client application 1010 to connect to a server application 1012. The client application 1010 must know the address of a server host 1015 and the port number of the server application 1012. Client applications 1010, e.g. web browser applications, do not need special port numbers. However, client port numbers need to be unique on a given host 1016 and are assigned by the operating system running on the host 1016.

If the client application 1010 knows the IP address of the host 1015 running an HTTP server and knows that the server application 1012 is assigned port number 80, then the client application 1010 can use TCP/IP to request information, e.g., web pages, from the HTTP server application 1012.

Encapsulation and the Protocol Stack

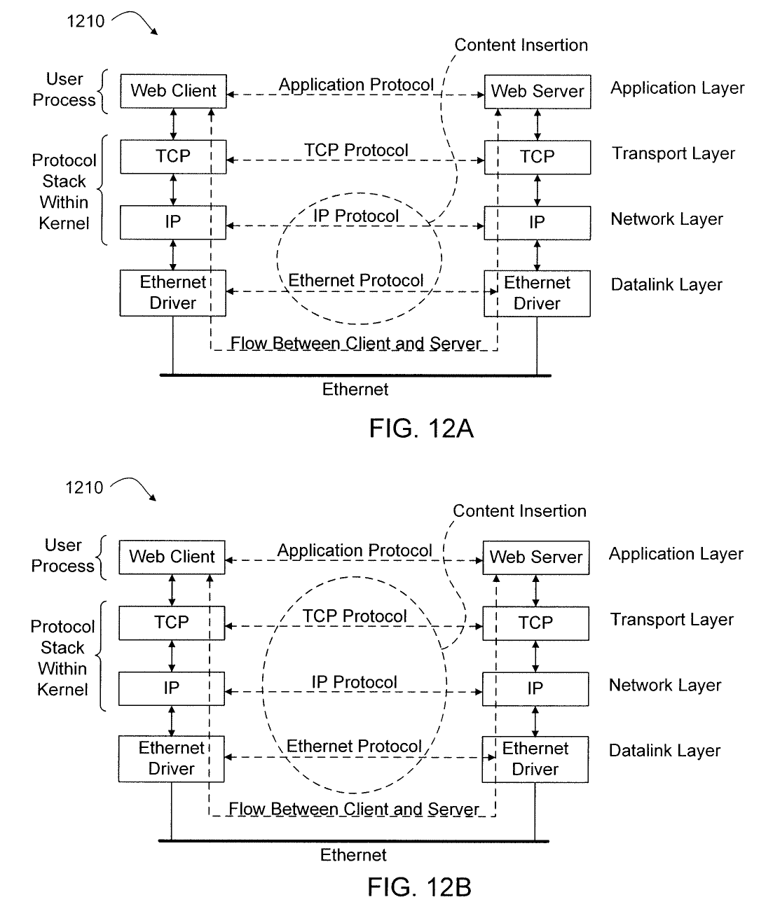

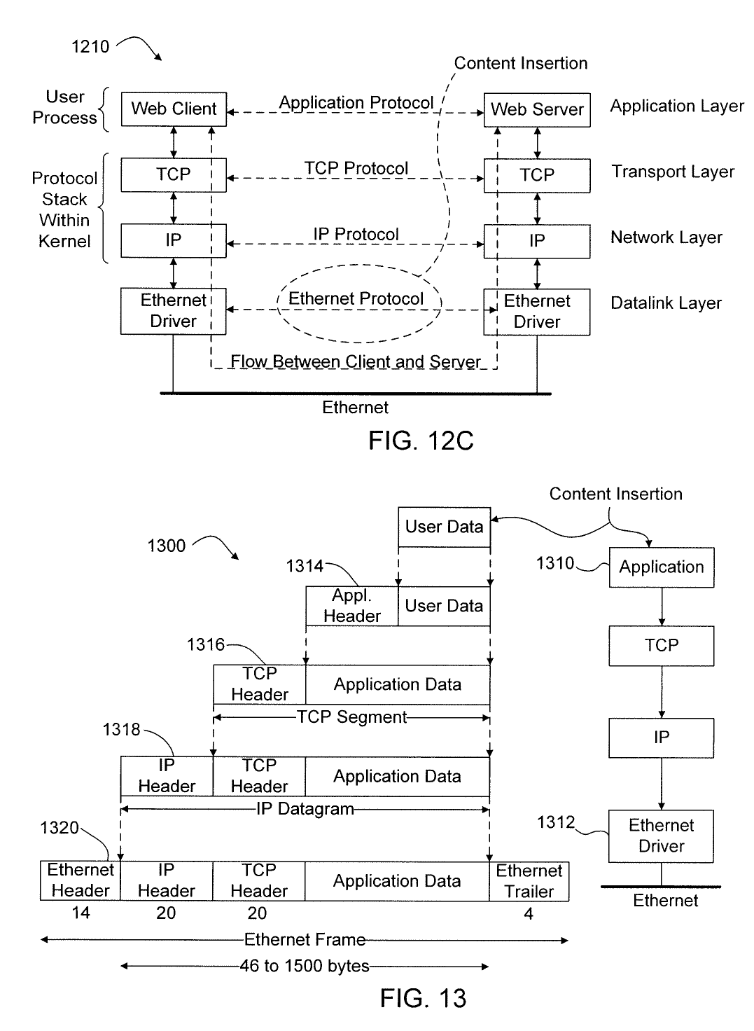

FIGS. 12A-12C are block diagrams illustrating the protocol stack 1210 on the client host 1016 and the server host 1015. The data that an application (e.g., the client application 1010 or the server application 1012) sends generally works its way down through each layer (e.g., application layer, transport layer, network layer, and datalink layer) of the protocol stack 1210 until it is converted into a stream of bits that are transmitted across the physical network (e.g., Ethernet). As the data descends, each layer adds information to the data it receives. The added information helps the data payload to reach its destination. This process 1300 is called encapsulation and is illustrated in FIG. 13.

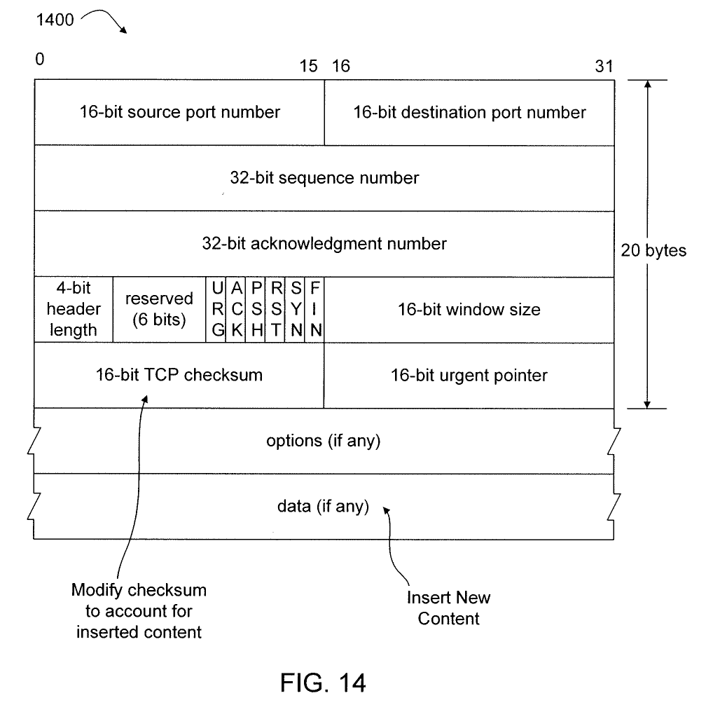

The TCP layer receives the application data and adds a 20-byte header to form a TCP segment. Included in a TCP header are the source application port number and the destination application port number. The TCP header also includes a 32-bit sequence number and other fields that will be described below. The TCP segment is passed down the stack to the IP layer. The structure 1400 of a TCP segment is illustrated in FIG. 14.

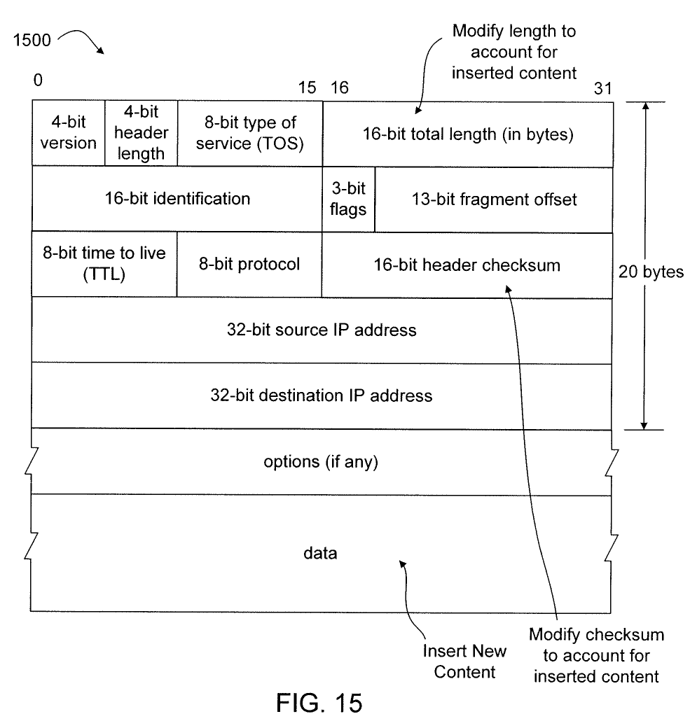

The IP layer adds a 20-byte header to the TCP segment to form the IP datagram. The IP header includes the four-byte IP addresses of the source host interface and of the destination host interface. The IP header also includes an identifier giving the identity of the protocol using IP. In the examples considered here, the TCP protocol uses IP. The IP header specifies the length (header and data) of the IP datagram in bytes. The IP datagram is passed down the stack to the link layer. The structure 1500 of an IP datagram is illustrated in FIG. 15.

The link layer (also known as the data-link layer or network interface layer) receives the IP datagram and adds the appropriate headers and trailers to form a frame. For example, if the physical link uses Ethernet, then the link layer would add a 14-byte header and a four-byte trailer. The header includes the physical hardware addresses of the network interface cards in the destination and source computers, six bytes for each address. The link layer uses the device driver installed in the operating system to access the network interface cards. The Ethernet frame header also identifies the frame type as IP.

Demultiplexing

At the destination host (e.g., either the client host 1016 or the server host 1015) specified in the Ethernet frame, the link layer removes the Ethernet frame header, discovers that the data is for IP, and passes it up the protocol stack to the IP layer. The IP layer reads the IP header and takes appropriate action. If this host is the destination host, and the protocol specified in the protocol header is TCP, then the IP layer removes the IP header and passes the data up the protocol stack to the TCP layer. The TCP layer reads the TCP header, looks up the port address of the destination application, removes the TCP header and passes the data up the protocol stack to the destination application. The above example illustrates a block of data passed successfully in one direction from a source application to a destination application.

Routing

For routing, the destination host specified in the Ethernet frame is a router 1014. As before, the link layer removes the Ethernet frame header, discovers that the data is for IP, and passes it up the protocol stack to the IP layer. The IP layer checks to see if the destination address matches one of its own addresses. If so, it checks the protocol field in the IP header and passes the data up the protocol stack to the appropriate protocol service.

If the IP datagram is destined for an IP layer on a different host, then the datagram is treated as an outgoing datagram and is forwarded on toward its destination by sending the datagram down the protocol stack to the link layer. The router 1014 stores a routing table used for forwarding datagrams. The routing table includes several pieces of information including: the destination host IP address or a network address; the IP address of a next-hop router through which the datagram can be sent to the final destination; and the network interface through which the datagram should be sent.

If a matching destination host IP address or network address is not found in the routing table, the datagram is forward to a default router in the hope that the default router will know how to route the packet toward its destination. IP datagrams are routed on a hop-by-hop basis and travel along a path through many routers from source host to destination host. Sometimes a router 1014 cannot forward a datagram and returns a “host unreachable” or “network unreachable” error to the application that generated the datagram.

Fragmentation

The server application 1012 may have a large data payload to be transmitted. Each layer in the stack can accommodate different length blocks of data. For example, the largest TCP segment is approximately 65,000 bytes. Ethernet frames, on the other hand, can be no larger that 1500 bytes. Therefore, as a data payload travels down the protocol stack on the source host 1015, it may need to be split up into smaller pieces. Additionally, as IP datagrams traverse a WAN, the physical networks (link layer) that are encountered may have different frame sizes. Therefore, datagrams may be split up during the course of transmission. The process of dividing the data may be referred to as fragmentation. When splitting up a large datagram into small ones, each of the smaller datagrams must have prepended an IP header with the appropriate fields copied from the original IP header. In addition to the fields described previously, the IP header includes three fields that are used for fragmentation and reassembly: 16-bit identification, 3-bit flags, and 13-bit fragmentation offset.

Datagrams may be fragmented several times while en-route to their destination. Reassembly is performed in the IP layer at the destination host 1016. The header in an IP datagram also includes a 16-bit total length field that indicates the total length in bytes of the IP datagram (header and data). When a datagram is fragmented, the length of a fragment is less than the length of the original datagram.

Internet Paths

There is no guarantee that the IP datagrams associated with a given block of application data travel along the same path from source to destination. As an example, consider the situation of an HTTP server application 1012 responding to a client application 1010 (web browser) request (e.g., in response to a user clicking a link). The server application 1012 responds by sending a large web page written in HTML. The web page is large and is fragmented as it moves down through the layers of the protocol stack. It is possible for each datagram to travel along different paths from the server host 1015 to the client host 1016. A path through the Internet is a sequence of hosts and routers through which the datagram passes from source to destination.

Research on Internet Paths

V. Paxson has performed studies (see, V. Paxson, “End-to-end routing behavior in the internet,” IEEE/ACM Transactions on Networking, vol. 5, pp. 601, 615, Oct. 1997, available at ftp://ftp.ee.lbl.gov/papers/vp-routing-TON.ps.gz; see also, V. Paxson, “End-to-end routing behavior in the internet,” Computer Communication Review, vol. 26, pp. 25-38, Oct. 1996, available at ftp://ftp.ee.lbl.gov/papers/routing.SIGCOMM.ps.Z) on a variety of aspects of paths between a pair of hosts on the Internet. Paxson defines prevalence as the likelihood that a particular path is encountered. The term persistence is defined as the likelihood that a path remains unchanged over a long period of time. Paxson found that “Internet paths are heavily dominated by a single prevalent” path and that about 80% of paths persist for durations longer than a day. Therefore, even though it is possible for fragmented data to traverse different paths, the reality is that, with high probability, fragmented datagrams follow the same path. Paxson also studied the symmetry of paths. In 1995, he found that the client-to-server path differed from the server-to-client path in about 30% of TCP connections.

TCP Connection Establishment and Termination

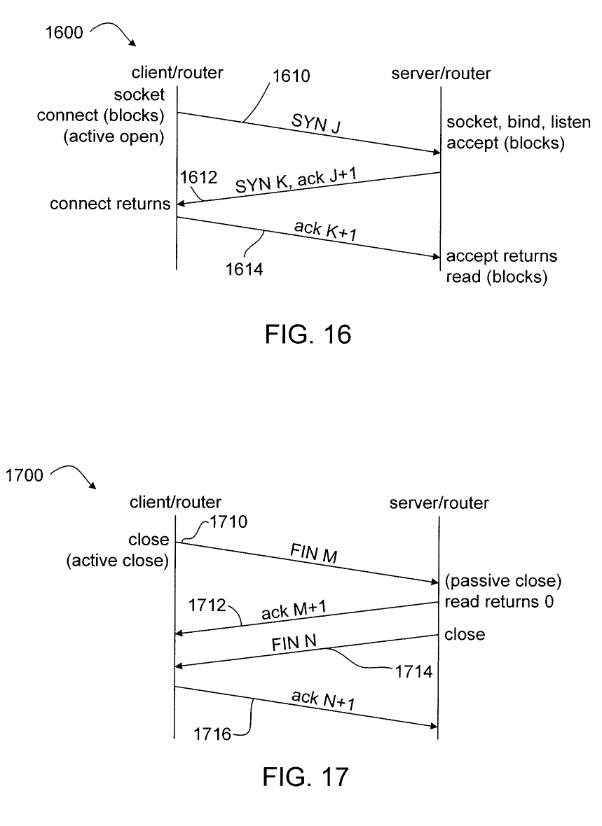

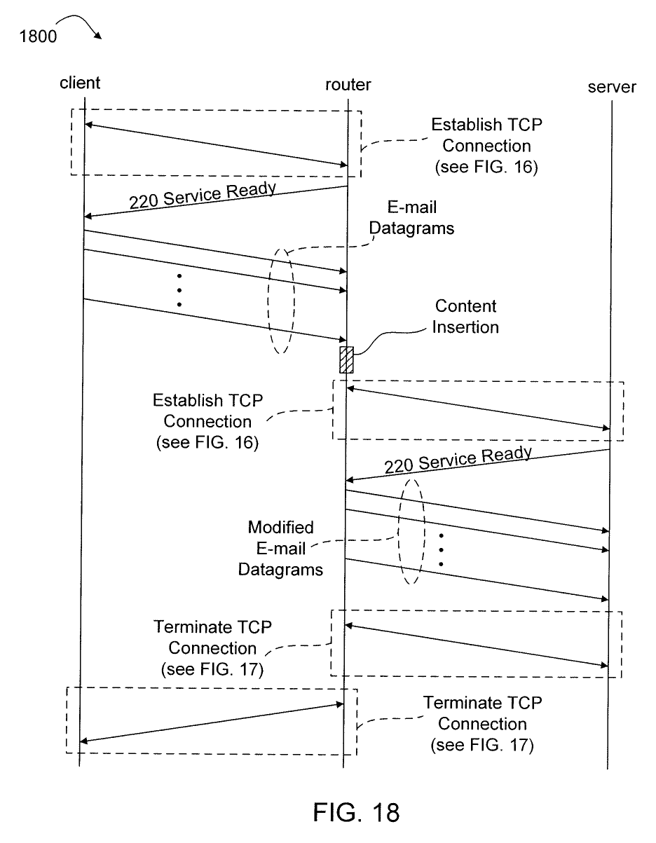

The manner in which TCP connections are established and terminated is considered when content is inserted into the TCP data stream. A TCP connection establishment exchanges three TCP segments between the two hosts 1015, 1016. For example, FIG. 16 illustrates a timing chart of an example transaction 1600 for establishing a TCP connection using three TCP segments 1610, 1612, 1614. Each segment is carried in a separate IP datagram. The first segment 1610 and the third segment 1614 are client-to-server directed. The second segment 1612 travels is server-to-client directed. This procedure is often referred to as the three-way handshake.

FIG. 17 illustrates a timing chart of an example transaction 1700 for terminating a TCP connection. As shown, the termination transaction 1700 generally requires four TCP segments 1710, 1712, 1714, 1716 resulting in four IP datagrams. The first segment 1710 and the fourth segment 1716 are client-to-server directed while the second segment 1712 and the third segment 1717 are server-to-client directed.

Thus, as shown in FIGS. 16 and 17, TCP connections between a client and a server are established and terminated by the exchange of multiple transmissions that occur in both directions. As discussed in detail below, the transactions shown in FIGS. 16 and 17 may also be used according to certain embodiments between a client and a router, and between a server and the router to simulate a connection between the client and the server.

Inserting Content into a TCP Stream

In one embodiment, a software program 1018 (content insertion software 1018) (see FIGS. 10-11) running on a router 1014 is configured to insert content into a TCP data stream and works within the confines of the protocol(s). The router 1014 sits somewhere on the path between the two hosts 1015, 1016. Since IP datagrams can travel different paths, there is a chance that the path may change during connection establishment, data transmission, or termination. The router 1014 running the insertion software 1018 may be in the path between hosts 1015, 1016 one instant and, if the path changes, may not be in the path the next instant. In one embodiment, it is simply assumed (based on the probability discussed above) that the path will not change in the few seconds required for a complete a HTTP or SMTP transaction. In other embodiments discussed in more detail below, the router 1014 inserts itself in a more controlled fashion in the path and forces the path to include it. Before describing these embodiments, the following discussion summarizes the HTTP and SMTP protocols and how they use the services of TCP.

As shown in FIG. 12A, the content insertion software 1018 according to one embodiment is configured to perform the scanning and content insertion processes discussed herein at the IP protocol and/or Ethernet protocol layers. In addition, or in other embodiments, as shown in FIG. 12B, the scanning and content insertion processes may also be performed at the TCP protocol layer. In another embodiment, as shown in FIG. 12C, the scanning and content insertion processes are performed entirely at the Ethernet protocol layer. In such an embodiment, the content insertion software 1018 may be part of, for example, an Ethernet driver 1312 shown in FIG. 13. In yet another embodiment, an application 1310 shown in FIG. 13 may include the content insertion software 1018. In such an embodiment, the application 1310 applies an appropriate application header 1314, the TCP layer automatically applies an appropriate TCP header 1316, the IP layer automatically applies an appropriate IP header 1318, and the datalink layer automatically applies an appropriate Ethernet header 1320 to a account for new content inserted at the application layer.

HTTP Protocol

The HTTP protocol is very simple and is described by the following steps. First, the client application 1010 (e.g., web browser) establishes a TCP connection to port 80 on the HTTP server host 1015. As explained above, this typically requires a three-way handshake. Second, the client application 1010 issues a request (e.g., a GET request). Third, the server application 1012 responds to the request with data which may be an HTML file, an image, etc. Fourth, the server application 1012 closes the connection.

Often the server's response is an HTML file which includes references to other content such as images. These elements do not come as part of the HTML file. Each element is downloaded separately via the four step procedure described above. The HTTP protocol includes other features. For example, in addition to a GET request, the client application 1010 may also issue HEAD and POST requests. The server application 1012 has a variety of three-digit response codes to report success, redirection, client errors, and server errors. Despite the request or response, the basic steps in the protocol are the same as outlined above.

SMTP Protocol

The SMTP protocol is only slightly more complicated than HTTP. Five commands are used in the SMTP protocol to send e-mail. The five commands are listed below in the order in which they generally occur. Each command is sent from the client side where the e-mail originates to the server side which is the destination of the e-mail message. Each client command is acknowledged by the server application 1012. SMTP uses a TCP connection. Therefore, before the SMTP protocol begins, a TCP connection is established by the three-way handshake discussed above. The sending mail transfer agent (MTA) establishes a TCP connection to port 25 on the server host 1015 and waits for a greeting message from the server host 1015. Then the MTA sends the following five commands.

1. HELO: the client application 1010 identifies itself to the server application 1012 using its IP address.

2. MAIL: the client application 1010 sends the identity (e-mail address) of the user that wrote the message.

3. RCPT: the client application 1010 sends the identity (e-mail address) of the recipient of the message.

4. DATA: the client application 1010 sends the body of the message.

5. QUIT: the client application 1010 ends the e-mail exchange.

There are a few other commands the client application 1010 can issue and a variety of three-digit response codes that the server application 1012 may reply with.

MIME

SMTP can only send messages consisting of NVT 7-bit ASCII formatted data. The multipurpose internet mail extensions (MIME) is an extension to SMTP to allow non-ASCII characters to be used for foreign languages and for other types of data. MIME converts non-ASCII data to ASCII and sends the result to SMTP for delivery. On the other end, MIME converts back to the original format. MIME adds elements to the SMTP header section (after HELO, MAIL, RCPT, but before DATA) to define how the conversion was made. This enables the reverse conversion to be performed at the other end. Using MIME, things such as HTML files and images can be embedded within e-mail messages. The insertions implemented by certain embodiments disclosed herein may use MIME.

Content Insertion

With the above description as a background, certain embodiments disclosed herein insert content into e-mail (SMTP) and web pages (HTTP) using insertion software 1018 running on a router or some other Internet connected hardware through which electronic traffic flows. There are several ways that an insertion can be made. The examples below outline the sequences of events followed by the protocols discussed above and explains the steps performed by a software program in order to insert new content into a message. Several examples are given that differ in the complexity of the software 1018 and the degree to which the software 1018 communicates with the applications running on the client host 1016 and the server host 1015.

Inserting Content into HTTP

As one example, consider the insertion of content at the end of an HTML document (a web page) that is being transported via the HTTP protocol. In particular, suppose the goal is simply to insert some text and an HTML link at the bottom of the web page. The overall effect of the insertion may be described as follows. A user sitting at the client host 1016 clicks a link in a web browser window. Following the HTTP protocol, a request is issued to the server host 1015 on the Internet. The server host 1015 responds by sending an HTML file via the HTTP protocol back to the web browser which renders the HTML in the browser window on the screen for the user to see. For this example, suppose the HTML file sent in the server's response includes the following code:

<HTML>
<BODY>
Here is the web page sent by the server.<br>
</BODY>
</HTML>

In a browser window, the HTML file with the code shown above renders as shown in FIG. 3A. However, according to certain embodiments described herein, instead of receiving the HTML file above, the content insertion software 1018 inserts new content at the end of the file, and the web browser receives an HTML file having the code shown below:

<HTML>
<BODY>
Here is the web page sent by the server.<br>
<br>
Here is the inserted text.
<A HREF=“http://www.info.org”>Click here</A>
</BODY>
</HTML>

In the browser window, the HTML file having the code shown above with the inserted content (Here is the inserted text. <A HREF=“http://www.info.org”>Click here</A>) renders as shown in FIG. 3B. The modified HTML document includes all of the information in the original HTML file without any modifications. The only difference is the insertion of a line of text and an HTML link that can be activated by clicking on the words “Click here” that are rendered in the web browser.

One embodiment for inserting content into an HTML file transported by HTTP includes:

1. A web browser application (e.g., the client application 1010) opens a TCP connection to port 80 on an HTTP server (e.g., the server application 1012). This requires the three way handshake described above involving three IP datagrams.

2. The web browser (client) issues a GET request. Most likely, the request is carried all the way to the server in a single IP datagram.

3. The server processes the request and sends a response. Suppose, in this example, that the response includes the simple HTML file given above. This is a short file and will probably be transported back to the client in a single IP datagram that does not get fragmented en-route.

4. The IP datagram carrying the response travels along a path through the Internet from the server back to the client. Suppose the path includes a router 1014 running the content insertion software 1018 as described herein.

5. The router 1014 receives a frame of data. In this example, suppose it is an Ethernet frame. The header and trailer are removed and the IP datagram is pushed up the protocol stack to the IP layer.

6. Routing is performed at the IP layer. The address of the client host is looked up and a routing decision is made. The Ethernet hardware address is determined so that the IP datagram can be forwarded on toward the client host.

7. The content insertion software 1018 determines by examining the IP header that the data payload in the IP datagram is for TCP. There is the potential that the data in the TCP segment is part of the response of an HTTP server. The data payload in the TCP segment may include an HTML file.

8. The content insertion software 1018 inspects the data in the TCP segment. It looks for the HTML tag: </BODY>. If it finds this tag, then it knows that this datagram includes the end of an HTML file, e.g., a web page. Thus, there is a potential opportunity to insert content.

9. The content insertion software 1018 inserts the text and HTML link shown in the example given above (Here is the inserted text. <A HREF=“http://www.info.org”>Click here</A>) into a data payload of the TCP segment (see FIGS. 14-15).

10. The insertion changes the data payload of the TCP segment. Therefore, the 16-bit checksum in the TCP header is recalculated (see FIG. 14).

11. The insertion changes the length of the data payload in the IP segment. Therefore, the 16-bit total length (in bytes) field in the IP header is incremented to reflect the change (see FIG. 15).

12. With the changes to the IP header, the 16-bit header checksum in the IP header is also recalculated (see FIG. 15).

13. The IP datagram is pushed down the protocol stack to the link layer and it is forwarded toward its destination, the client host, via the Ethernet.

The above example illustrates how a simple insertion can be performed. In summary, the content insertion software 1018 detects the presence of the end of an HTML document, makes the insertion, and modifies the appropriate fields in TCP and IP headers. Note that the data payload of the TCP segment can be scanned, and content inserted if appropriate, while routing decisions are being made. Because the insertion can be done in parallel with the routing tasks, there is the potential that in many cases the insertion will not add any latency in the overall transmission.

More complexity can be added to the above example. As an incremental increase in complexity, suppose that the web page in the server response is very long and does not fit into a single IP datagram. In this case, the content insertion software 1018 acts the same as before. It looks for the end of the HTML file, performs the insertion, and the appropriate header adjustments. If the length of the original HTML data in the TCP segment plus the length of the inserted content exceeds the maximum transfer unit (MTU), then the TCP segment is fragmented as it descends the protocol stack to the IP layer. The TCP/IP protocols are configured to handle fragmentation during transmission and the reassembly at the receiving end on the client. The web browser running on the client host has no way of differentiating the inserted text from the original text. Both are displayed in the browser window.

Inserting Content into SMTP

Inserting content into an SMTP message may be more complicated depending on the content to be inserted. If the e-mail message is plain text and the content to be inserted is plain text, then the insertion is quite simple. Much like the HTTP protocol, the content insertion software 1018 inspects the IP datagrams passing by. When the end of an e-mail message is detected, text is inserted. The insertion may happen at the TCP layer (see FIG. 12B) and, as the data pass back down the stack, fragmentation may take place. As discussed above, the fields in the IP headers are recomputed by the IP layer.

Generally, many e-mail applications (e.g., programs used to read and send electronic mail) may display e-mail messages formatted as HTML. Inserting plain text or HTML content into an e-mail message that is already formatted as HTML is as simple as inserting content in the HTTP protocol example provided above. The body of the e-mail message includes HTML formatted text and may be split up into fragments at the IP layer. The content insertion software 1018 monitors received IP datagrams. As in the HTTP example discussed above, it scans the data payload at the TCP layer (see FIG. 12B). If it finds a </BODY> tag, it may insert plain text or HTML code.

In addition, or in other embodiments, HTML tags are inserted into a plain text e-mail message. This is difficult because the structure of the e-mail message is changed. Both header and body are modified. However, the header and body are sent separately and in sequence. It is difficult to perform a modification on a sequence of packets. However, the modification may be done easily if the entire e-mail message is available to the content insertion software 1018.

Therefore, in order to make this type of modification according to one embodiment, the content insertion software 1018 (an application) inserts itself actively in the communication process in a way that fools the client application 1010 into thinking that it is communicating with the server application 1012 when in fact it is not. Such a bluff controls the path between the client host 1016 and the server host 1015 such that the path consistently includes the insertion host (e.g., the router 1014 running the content insertion software 1018) so that the insertion host intercepts all of the IP datagrams transmitted from the client toward the server. If one IP datagram follows a different path that does not include the insertion host, then the whole process may be foiled and the e-mail message may not get transferred. The MTA may make another attempt to transfer the message. In such a case, the content insertion software 1018 may limit the number of times that it tries to insert new content into a given e-mail message. Thus, the content insertion software 1018 in one embodiment does not prevent mail exchanges.

Referring to FIG. 18, which is an example timing chart of a transaction for inserting content into an e-mail according to one embodiment, a router can insert itself into a path between a client and a server using the following example steps. E-mail transfer by SMTP is used in this example.

1. A mail transfer agent (MTA) running on the client (sending) host 1016 tries to open a TCP connection to the e-mail server on the receiving host 1015. It does this by sending an IP datagram which is the first datagram in the three way handshake shown in FIG. 16.

2. This IP datagram is picked up by the content insertion software 1018 running on the insertion host. By analysis of the TCP header in the datagram (this analysis may be performed at either the IP layer (see FIG. 12A) and/or the TCP layer (see FIG. 12B)) the content insertion software 1018 detects that this is the first IP datagram in a three-way handshake for establishing a TCP connection to a port that is used for e-mail transfer (port 25).

3. The content insertion software 1018 pretends to be the desired mail server and returns the required acknowledgment in an IP datagram.

4. The client acknowledges the acknowledgment in the third IP datagram and the three-way handshake is complete.

5. After a normal TCP connection has been established, the server sends a “220 service ready” message to the client. Since all the IP datagrams have been intercepted by the insertion application, the content insertion software 1018 sends the “220” message back to the client. At this point, the client thinks it has connected to the server and will start to transfer e-mail according to the SMTP protocol. The content insertion software 1018 picks up each and every datagram and responds in appropriate ways according to SMTP.

6. To indicate the end of the body of the e-mail message, the client sends a line containing only a “.”. This is the signal to the server that the full e-mail message has been sent.

7. At this point, the content insertion software 1018 has the entire e-mail message. The e-mail message may be reformatted in HTML with additional content inserted. The content of the original e-mail message is preserved.

8. Now that the inserted content has been added to the e-mail message, the second phase of e-mail transfer may begin. The insertion application opens a TCP connection with the destination e-mail server and transfers the e-mail according to the SMTP protocol. In this phase, there is little or no danger in IP datagrams traveling alternate routes because the TCP connection is between the insertion application and the destination mail server.

9. When the insertion application has successfully transferred the mail to the destination mail server via SMTP, it turns around and finishes off the SMTP protocol exchanges with the e-mail client including the four-way handshake shown in FIG. 17 to close the TCP connections. The e-mail has been successfully transferred with successful insertion of new content. If problems arise in the second phase, the insertion application may notify the client of the failure and the client will make another attempt to transfer the e-mail.

The description above, explains how the content insertion software 1018 running on a host (e.g., a router 1014 that falls on the path between a client application 1010 and a server application 1012) can insert itself actively into the message passing. Provided the content insertion software 1018 sees all the IP datagrams sent from the client to the server, it can effectively mimic the server and receive an e-mail message in its entirety. Suitable modifications may be made while preserving the original message content. The message can then be sent reliably to the final destination.

Another embodiment using active insertion is when an HTTP server sends its information in an encoded format. Some HTTP servers send HTML web pages in a compressed format. This is more efficient than sending HTML in plain text format. However, in order for content to be inserted, the entire body of the message must be intercepted and decompressed to give the original HTML. Then, the new content may be inserted. The modified HTML file may again be compressed (or not) and sent on to the client.

In order to have a more controlled and reliable, non-simulated connection between the client application 1010 and the insertion application 1012, in the case of HTTP, features available in the protocol may be used. For example, one of the codes that an HTTP server can return to the client is a “304 moved temporarily” code. This code tells the client that the requested URL has moved temporarily to another host.

The content insertion software 1018 may perform the three-way handshake to simulate the TCP connection with the server and, after the client request is received, may return a “304” status code redirecting the client to make another request from a different URL. The redirected URL may be the insertion software/host itself or some other controlled host. Then, the client may make a TCP connection with the insertion software 1018. In this way, the insertion application may insert itself between the client and the server. To the client it acts like the server. To the server it acts like the client. The content insertion software 1018 passes the client's requests through to the server and passes the server responses back to the client after suitably inserting content into HTML formatted documents.

There are secure versions of HTTP that encrypt the HTML. Insertion may not be possible in these cases. However, in one embodiment, users may grant access (e.g., decryption keys) to the content insertion software 1018 to decrypt the HTML so new content may be inserted therein.

In certain embodiments disclosed herein, it was assumed that the content insertion software 1018 runs on an Internet connected router 1014. However, such routers 1014 may already be busy with their tasks. Thus, in one embodiment, a separate device (not shown) is specifically dedicated to the task of filtering IP datagrams and TCP segments looking for opportunities to insert new content. This additional device may also handle TCP connections with servers and simulating TCP connections with clients.

Some users may not like to have content inserted into their SMTP and/or HTTP exchanges. For these users, a browser plug-in could be provided that could filter out inserted content based on tags embedded in the inserted HTML.

In another embodiment, as discussed above, users may visit a web site (profile site) where they can enter a personal user profile indicating the types of content that may and may not be inserted into their SMTP and/or HTTP exchanges. In this case, before an insertion is made, the content insertion software 1018 may obtain (according to certain protocols) information from the profile site about the types of acceptable content that may be inserted. The profile site may also maintain a national (or even world wide) “do not insert” list, as discussed above.

It will be obvious to those having skill in the art that many changes may be made to the details of the above-described embodiments without departing from the underlying principles of the invention. The scope of the present invention should, therefore, be determined only by the following claims.

What is claimed is:

1. A router for inserting content into messages being sent between two or more networks, the router comprising:
a routing module to receive a data packet corresponding to a message being sent between a first network and a second network, the data packet comprising a header and a content payload; and
a content insertion module configured to:
determine that the data packet comprises a predetermined type of content payload; and
modify the data packet by automatically inserting new content into the payload,
wherein the routing module is configured to forward the modified data packet toward the second network.

2. The router of claim 1, wherein the new content comprises an announcement from a government agency.

3. The router of claim 2, wherein the announcement comprises an alert that a person has been abducted.

4. The router of claim 2, wherein the announcement comprises a weather advisory.

5. The router of claim 2, wherein the announcement comprises a natural disaster advisory.

6. The router of claim 2, wherein the announcement comprises a national security advisory.

7. The router of claim 1, wherein the new content comprises a traffic report.

8. The router of claim 1, wherein the new content comprises a stock report.

9. The router of claim 1, wherein the new content comprises an advertisement.

10. The router of claim 1, wherein the predetermined type of content payload comprises an e-mail.

11. The router of claim 1, wherein the predetermined type of content payload comprises a web page.

12. The router of claim 1, wherein the predetermined type of content payload comprises a text message.

13. The router of claim 1, wherein the content insertion module is further configured to determine that the data packet comprises a predetermined insertion point.

14. The router of claim 13, wherein automatically inserting new content into the payload comprises inserting the new content at the insertion point.

15. The router of claim 13, wherein the predetermined insertion point comprises an end of the message.

16. The router of claim 1, wherein the content insertion module is further configured to:
determine whether a packet size limit is exceeded by inserting the new content into the data packet; and
if the packet size limit is exceeded, splitting the data packet into a plurality of data packets that are each within the size limit.

17. The router of claim 1, wherein the content insertion module is further configured to update error detection data in the header to account for the inserted content.

18. The router of claim 1, wherein the content insertion module is further configured to update length data in the header to account for the inserted content.

19. The router of claim 1, wherein the content insertion module is further configured to:
determine whether the received data packet corresponds to a previously modified data packet;
determine whether the previously modified data packet was modified within a predetermined time frame; and
prevent the automatic insertion of the new content if the previously modified data packet was modified within the predetermined time frame.

20. The router of claim 1, wherein the content insertion module is further configured to:
determine whether the received packet is encoded;
receive additional packets corresponding to the message being sent between the first network and the second network if the received packet is encoded;
decode the message;
insert the new content into the decoded message; and
forward the modified message toward the second network.

21. The router of claim 20, wherein the content insertion module is further configured to re-encode the modified message before forwarding it toward the second network.

22. The router of claim 1, wherein the content insertion module is further configured to simulate a client-server communication protocol between the first network and the second network.

23. The router of claim 1, wherein at least one of the predetermined types of content payload and the subject matter of the new content inserted into the payload are based on user selectable preferences.

24. A method for inserting content into messages being sent through a network, the method comprising:
receiving a data packet comprising a header and a content payload;
determining that the data packet comprises a predetermined type of content payload;
modifying the data packet by automatically inserting new content into the payload; and
forwarding the modified data packet toward its intended destination.

25. The method of claim 24, further comprising determining that the data packet comprises a predetermined insertion point.

26. The method of claim 25, wherein automatically inserting new content into the payload comprises inserting the new content at the predetermined insertion point.

27. The method of claim 25, wherein the predetermined insertion point comprises an end of a message, the data packet corresponding to the message.

28. The method of claim 24, further comprising:
determining whether a packet size limit is exceeded by inserting the new content into the data packet; and
if the packet size limit is exceeded, splitting the data packet into a plurality of data packets that are each within the size limit.

29. The method of claim 24, further comprising updating error detection data in the header to account for the inserted content.

30. The method of claim 24, further comprising updating length data in the header to account for the inserted content.

31. The method of claim 24, further comprising:
determining whether the received data packet corresponds to a previously modified data packet;
determining whether the previously modified data packet was modified within a predetermined time frame; and
preventing the automatic insertion of the new content if the previously modified data packet was modified within the predetermined time frame.

32. The method of claim 24, further comprising:
determining whether the received packet is encoded;
receiving additional packets if the received packet is encoded;
decoding a message corresponding to the received packet and the additional packets;
inserting the new content into the decoded message; and
forwarding the modified message toward its intended destination.

33. The method of claim 32, further comprising re-encoding the modified message before forwarding it toward its intended destination.

34. The method of claim 24, further comprising:
simulating a connection between a client and a server so as to receive a plurality of packets, in addition to the received packet, corresponding to a particular message;
inserting the new content at a predetermined location within the particular message; and
forwarding the particular message toward its intended destination.

35. The method of claim 34, wherein the particular message comprises an e-mail message being sent from the client to the server.

36. The method of claim 34, wherein the particular message comprises a web page being sent from the server to the client.

37. A system comprising:
means for intercepting a message sent between a server application and a client application;
means for inserting new content into the message; and
means for routing the modified message between the server application and the client application,
wherein the means for inserting and the means for routing substantially operate in parallel with each other to insert the new content as the routing information is being generated.

38. The system of claim 37, further comprising means for inserting the new content at a predetermined insertion point with the message.

39. A computer readable medium having stored thereon computer executable instructions for performing a method for inserting content into messages being sent through a network, the method comprising:
receiving a data packet comprising a header and a content payload;
determining that the data packet comprises a predetermined type of content payload;
modifying the data packet by automatically inserting new content into the payload; and
forwarding the modified data packet toward its intended destination.

40. The computer readable medium of claim 39, further comprising determining that the data packet comprises a predetermined insertion point.

41. The computer readable medium of claim 40, wherein automatically inserting new content into the payload comprises inserting the new content at the predetermined insertion point.

42. The computer readable medium of claim 40, wherein the predetermined insertion point comprises an end of a message, the data packet corresponding to the message.

43. The computer readable medium of claim 39, further comprising:
determining whether a packet size limit is exceeded by inserting the new content into the data packet; and
if the packet size limit is exceeded, splitting the data packet into a plurality of data packets that are each within the size limit.

44. The computer readable medium of claim 39, further comprising updating error detection data in the header to account for the inserted content.

45. The computer readable medium of claim 39, further comprising updating length data in the header to account for the inserted content.

46. The computer readable medium of claim 39, further comprising:
determining whether the received data packet corresponds to a previously modified data packet;
determining whether the previously modified data packet was modified within a predetermined time frame; and
preventing the automatic insertion of the new content if the previously modified data packet was modified within the predetermined time frame.

47. The computer readable medium of claim 39, further comprising:
determining whether the received packet is encoded;
receiving additional packets if the received packet is encoded;
decoding a message corresponding to the received packet and the additional packets;
inserting the new content into the decoded message; and
forwarding the modified message toward its intended destination.

48. The computer readable medium of claim 47, further comprising re-encoding the modified message before forwarding it toward its intended destination.

49. The computer readable medium of claim 39, further comprising:
simulating a connection between a client and a server so as to receive a plurality of packets, in addition to the received packet, corresponding to a particular message;
inserting the new content at a predetermined location within the particular message; and
forwarding the particular message toward its intended destination.

50. The computer readable medium of claim 49, wherein the particular message comprises an e-mail message being sent from the client to the server.

51. The computer readable medium of claim 49, wherein the particular message comprises a web page being sent from the server to the client.
